(19) United States
(12) Patent Application Publication
(10) Pub. No.: US 2012/0183271 A1
(43) Pub. Date: Jul. 19, 2012

(54) PRESSURE-BASED VIDEO RECORDING

(75) Inventors: Babak Forutanpour, San Diego, CA (US); Brian Momeyer, Carlsbad, CA (US); Karthic Veera, San Diego, CA (US)

(73) Assignee: QUALCOMM Incorporated, San Diego, CA (US)

(21) Appl. No.: 13/007,792

(22) Filed: Jan. 17, 2011

(51) Int. Cl. H04N 5/91

(52) U.S. Cl. 386/224; 386/E05.003

(57) ABSTRACT

This disclosure describes techniques for allowing a user to indicate the significance of portions of a video during video capturing by applying pressure to a surface of a video capture device. The user may indicate different levels of significance of different portions of the video by applying different amounts of pressure. The captured video may be encoded with the amount of applied pressure. During encoding, portions with applied pressure may be encoded using a different coding quality than portions with no applied pressure. Additionally, during editing and/or playback of the captured video, portions with applied pressure may be displayed and/or played back differently from portions with no applied pressure.

### TECHNICAL FIELD

The disclosure relates to video recording and, more particularly, to techniques for controlling video recording.

### BACKGROUND

Video capturing and processing capabilities can be incorporated into a wide range of devices, including wireless communication devices, personal digital assistants (PDAs), laptop or desktop computers, digital cameras, digital recording devices, cellular or satellite radio telephones, digital media players, and the like.

A video capture device, e.g., a video camera, captures video and sends it to a video encoder for encoding. The video encoder processes video frames, encodes the processed video frames, and transmits the encoded video data for storage or decoding and display. A user may further edit the captured video to personalize the video to the user's preference. During editing, a user may wish to remove portions of the video, add objects such as text and graphics, change display and playback preferences, and/or the like.

### SUMMARY

This disclosure describes techniques for identifying and marking video frames during video capture. A video capture device, such as a stand-alone video camera or a computing device incorporating video-capturing capabilities, may analyze video information and user input information to identify and mark video frames with indicators that can be used during subsequent encoding, editing, and/or playback of the video frames. The identified frames may correspond to frames that were captured, while the user was applying pressure to a pressure sensor associated with the video capture device. The pressure sensor may be formed at least in part by a display screen of the video capture device. The pressure applied by a user when a frame is presented on the display screen may indicate that the frame is of significance. In some examples, different levels of pressure may indicate different levels of significance of various frames. In one example, the device may mark the identified frames to indicate that the user applied pressure during capture of the frames. In some examples, the device may mark the identified frames with values corresponding to amounts of pressure applied by the user coincidentally with the capture of the frames.

In one example, this disclosure describes a method comprising detecting pressure applied by a user to a surface of a video capturing device for a plurality of video frames; and marking at least some of the frames to indicate a significance of the frames based on the detected pressure.

In another example, this disclosure describes a device comprising a sensor that detects pressure applied by a user to a surface of a video capturing device for a plurality of video frames; and at least one processor that marks at least some of the frames to indicate a significance of the frames based on the detected pressure.

In another example, this disclosure describes a device comprising means for detecting pressure applied by a user to a surface of a video capturing device for a plurality of video frames; and means for marking at least some of the frames to indicate a significance of the frames based on the detected pressure.

The techniques described in this disclosure may be implemented in hardware, software, firmware, or any combination thereof. If implemented in software, the software may be executed in one or more processors, such as a microprocessor, application specific integrated circuit (ASIC), field programmable gate array (FPGA), or digital signal processor (DSP). The software that executes the techniques may be initially stored in a computer-readable medium and loaded and executed in the processor.

Accordingly, this disclosure also contemplates a computer-readable storage medium comprising instructions that upon execution by a processor in a video processing device to detect pressure applied by a user to a surface of a video capturing device for a plurality of video frames; and mark at least some of the frames to indicate a significance of the frames based on the detected pressure.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1A is a block diagram illustrating an exemplary video capture device.

FIG. 1B is a block diagram illustrating an exemplary video system, in accordance with this disclosure.

FIGS. 2A-2B illustrate exemplary user interaction with a mobile device, in accordance with this disclosure.

FIGS. 3A-3B are block diagrams illustrating exemplary encoding of pressure information with video content.

FIG. 4 is a flow diagram illustrating video capturing and marking using example techniques of this disclosure.

FIG. 5 is a flow diagram illustrating video playback using example techniques of this disclosure.

FIG. 6 is a flow diagram illustrating video display using example techniques of this disclosure.

FIGS. 7A-7C illustrate exemplary screen shots of a computing device showing examples of video display, in accordance with this disclosure.

FIG. 8 illustrates an exemplary screen shot of a computing device showing an example playback of a video, in accordance with this disclosure.

FIG. 9 illustrates an exemplary screen shot of a computing device showing an example display of video clips, in accordance with this disclosure.

### DETAILED DESCRIPTION

This disclosure describes techniques for identifying and marking video frames during video capture based on detected pressure applied by a user on a display screen of a video capture device. The identified frames may be subsequently encoded, edited, and/or played back in a manner different from the non-identified frames. In one example, the frames may be marked with a significance indicator if the user applies pressure when the frame is captured. In some example, the frames may be marked with a pressure value, which may indicate an actual or relative amount of pressure applied to the frame, permitting frames to be marked with different levels of significance. The techniques of this disclosure may be applied during playback of a captured video, such that a user may apply pressure during playback of certain frames to identify and mark the frames based on the detected pressure.

In one example, a pressure indicator may be encoded with the video frames to indicate whether or not the user applied pressure during video capture. In another example, the pressure values may be encoded with the video frames to indicate whether or not the user applied pressure during video capture and in cases where the user applied pressure, the amount of pressure as indicated by the pressure value. The pressure indicator and/or the pressure values may be encoded with the video frames, in a header file, or stored in a separate file (e.g., separate track, text file, table of pressure value, and the like). The pressure indicators and/or values associated with the frames may be subsequently used to determine coding quality of the frames, for editing purposes, and/or during playback of the video frames. In one example, the average amount of pressure applied to each video clip of several video clips may be determined and used to display the video clips in an order of the average amount of applied pressure.

In one example, the pressure value may be utilized to sort the frames of a video clip in an order corresponding to the amount of pressure applied to the frames. In another example, the pressure value may be utilized to determine a playback speed of the frames, such that frames associated with more detected pressure (i.e., frames of greater significance) may be played back at a slower speed relative to frames associated with less detected pressure (i.e., frames of less significance). In other examples, the encoding process may be modified according to the pressure value, where frames with more pressure may be encoded at a higher quality, e.g., higher coding bit rate. The improvement in the coding quality, in some examples, may be proportional to the amount of pressure the user applied while the frame was being captured.

In other examples, the above applications of sorting the frames, playing back frames at different playback speeds, using different coding qualities to encode frames may be based on whether or not pressure was applied to the frame during video capturing, regardless of the amount of pressure applied. In some examples, during video capturing, the display may provide an indication as to whether the user is applying pressure and/or the amount of pressure the user is applying. In some examples, the pressure a user applies may result in marking frames with corresponding applied pressure, by detecting the pressure applied at the time a frame is captured. In other examples, the applied pressure may result in marking a group of frames, where the group of frames may be a set number of frames (e.g., 30 frames) or a number of frames captured in a specific amount of time (e.g., one second).

While capturing video, a user may capture moments that he/she identifies as significant (e.g., a child's first steps, or a great performance during a concert), and may wish to find the corresponding frames later during editing or playback of the captured video. Often, a user may capture several videos (e.g., video clips) and each video clip may vary in length. As a result, it may be hard for a user to easily locate videos that had interesting moments or portions, and within each video it may take the user a long time to locate the portions he/she deemed interesting while capturing the video. In some instances, a user may wish to only play back certain significant portions of the captured video, and finding those portions may be challenging, especially if the captured video is lengthy and/or there are many portions the user deems significant throughout the captured video. Using the techniques of this disclosure, the user may mark portions of interest of the video during video capturing, eliminating the need for the user to manually go through the video after capture is complete to identify frames where something of interest might have occurred or frames that the user wants to play back without playing back the entire captured video.

A video capture device, e.g., a camcorder or a video camera built into a computing device, may be used to capture the video. In some examples, the video capture device may reside in a mobile computing device, such as a mobile phone, tablet, personal digital assistant (PDA), or the like. The video capture device may utilize force or pressure sensors to detect when force is applied by a user to a surface such as a display screen of the video capture device. The display screen may be a conventional touchscreen that can detect an amount of force applied to the screen. The touchscreen may be a resistive, capacitive, or other type of touchscreen. In general, pressure is a measure of force per unit area, and is therefore proportional to force. For simplicity of the discussion of the techniques of this disclosure, the term “pressure” will be used generally interchangeably with the term “force” to refer to force or pressure applied by a user to a surface, whether concentrated at a point or distributed over an area.

Some example sensors may be capacitive or resistive force sensors, gasket-type resistive force sensors, or piezoelectric ceramic or PVDF (Polyvinylidene Fluoride) piezo material built into the touch screen or the computing device. In some examples, the sensors may provide static force-sensing (e.g., using discrete sensors placed under a touchscreen or surface of the computing device) or dynamic force-sensing (e.g., using sensors or sensing materials built into the touchscreen or computing device). The sensors may provide a force measurement, indicating an amount of force sensed when a user applies force to the display screen (or other surface) of the video capture device. The force, while measurable in various units of measure, may be sensed in terms of capacitance, resistance, voltage, or current levels, or other electrical parameters, or corresponding digital values, produced by sensors of the touchscreen within the video capture device. Placement and functionality of the sensors is discussed in more detail below.

The video capture device may detect the pressure, the amount of pressure applied, and/or the location of the pressure on the display screen. In accordance with techniques of this disclosure, the detected pressure may be associated with a frame or a group of frames being captured or displayed while the user applies the pressure, i.e., temporally coincident with the frame capture or frame display. The associated frame may be identified and marked with an indication of the detected pressure. In some examples, the video capture device may detect the presence of pressure, which may indicate that the associated frame or group of frames is significant. In other example, the video capture device may detect the presence of pressure and the amount of pressure applied, which may be an indicative value of the significance of the video frame, for example, how significant the user thinks the video frame is compared to other frames based on the amount of pressure.

In one example, marking a frame may include, for example, adding information regarding the detected pressure to the header of the corresponding frame. In another example, marking a frame may include generating a separate file (e.g., text or data file) or track (e.g., similar to an audio track), where information regarding the detected pressure may be stored. In one example, the frame pressure information may be listed in the same order as the frames and the separate file may be sent for further processing with the captured video, where a 0 entry may be indicated for frames where no pressure was detected. In another example, the frame pressure information may be stored along with a timestamp, a sequence identification number, or other identifier associated with the corresponding frame.

In one example, the marked portions or frames of the captured video may be presented to the user as thumbnails, where the user may select a thumbnail to edit or manipulate one or more corresponding video frames, or play back or display one or more corresponding frames. The corresponding video frames may be a portion of an overall video clip. As noted above, the user may apply pressure to indicate significance of a frame or group of frames relative to frames to which the user does not apply pressure, or the user may apply different amounts of pressure to indicate different levels of significance of an identified frame or group of frames of the captured video. During playback, the thumbnails of the marked frame or frames may be displayed in a manner corresponding to the level of significance indicated by the user. In some examples, the marked frames may be sorted and presented in an order such that the marked frames are presented first or more conspicuously to the user for editing or playback purposes.

Aspects of this disclosure may be utilized in any of a variety of devices that may incorporate video capturing capabilities. For purposes of this discussion, a video camera in a mobile phone is used as an exemplary video capture device. However, it should be understood that aspects of this disclosure may be implemented by a variety of stand-alone video processing devices or systems, or other computing devices and systems that have a video capturing component, among other components, such as mobile phones, laptop computers, tablet computers, desktop computers, personal digital assistants, or the like. It should also be understood that for purposes of this discussion, “frame” may refer to a video frame forming part of a sequence of video frames in a movie or video clip.

While the techniques of this disclosure are discussed in terms of identifying significant portions of a video clip during video capturing, these techniques may be applied during playback of a video clip. For example, a user may play back a captured video clip, and during playback, the user may apply pressure to indicate certain frames or portions of the video clip are significant. In one example, the user may apply pressure to portions he/she considers significant to distinguish these portions from other portions that he/she does not consider significant and to which no pressure is applied. In another example, the user may apply different amount of pressure to portions of the video clip during playback to indicate different levels of significance associated with the identified portions.

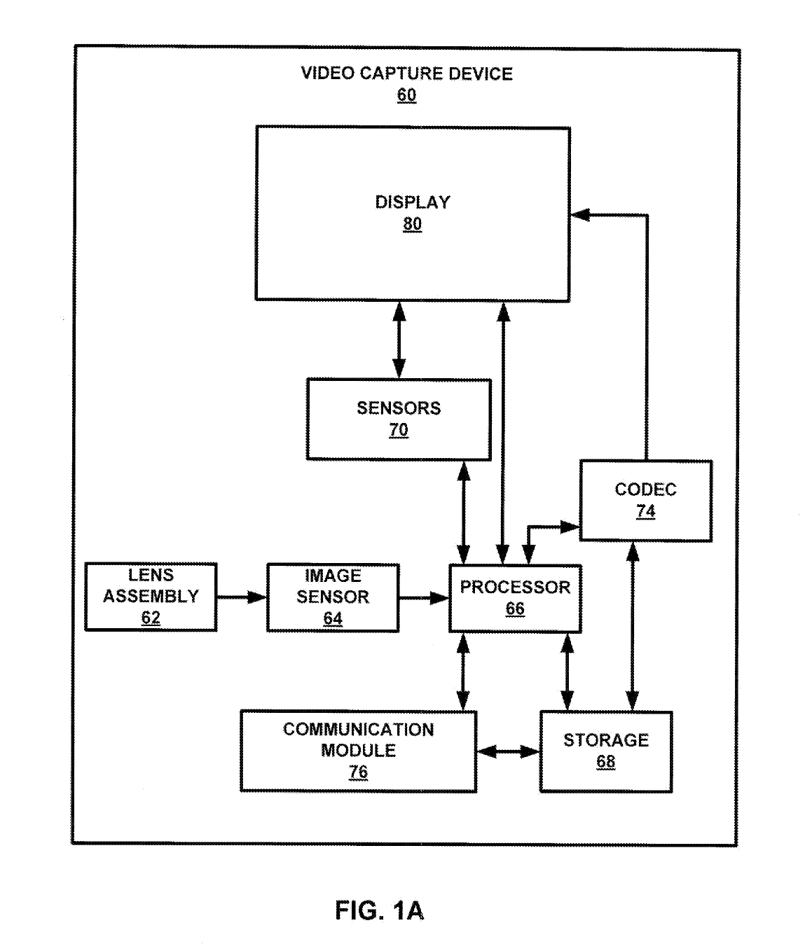

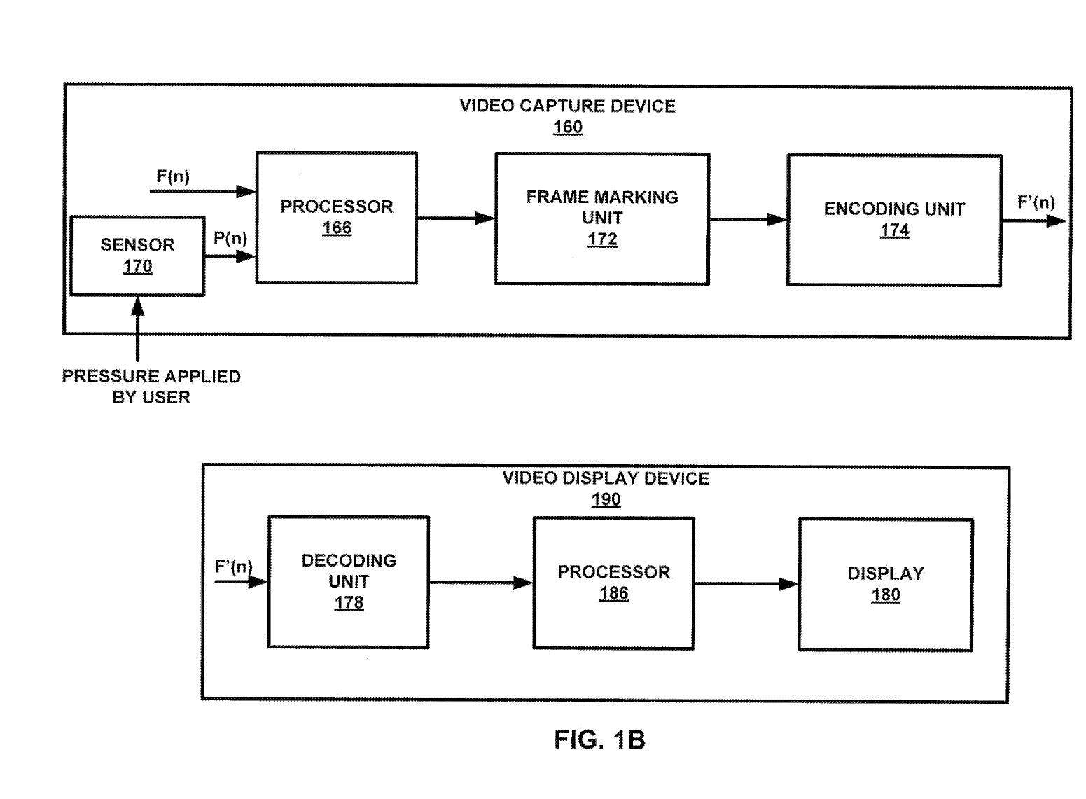

FIG. 1A is a block diagram illustrating an exemplary video capture device 60. Video capture device 60 may comprise, among other components, lens assembly 62, image sensor 64, processor 66, storage 68, sensors 70, video codec 74, and display 80. Video capture device 60 may be a dedicated video capture device (e.g., camcorder) or may be part of an image capture device (e.g., a digital camera), which may include a combination of a digital video camera and a digital still camera. Video capture device 60 may be a stand-alone device or may form part of another device that incorporates a still or video camera, such as a wireless communication device handset, a mobile device, or the like. In some aspects, video capture device 60 may also include a microphone to capture audio.

Storage 68 may be a dedicated data storage device for video capture device 60 or may be a portion of a data storage device associated with a computing device into which video capture device 60 may be incorporated. Storage 68 may be, for example, random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

Processor 66 may comprise one or more processors capable of performing one or more of processing captured images; controlling display 80; encoding images; decoding encoded images for display; transmitting encoded images to another device for decoding and display.

Lens assembly 62 may include one or more lenses and may be controlled by lens actuators that move the lens in lens assembly 62 among a plurality of different lens positions to focus the lens for capturing a scene. In some examples, lens assembly 62 may not be controlled by lens actuators, and may instead adjust focus digitally or in response to user input defining focus locations in the scene being captured.

Image sensor 64 may include image sensor elements such as, for example, a charge coupled device (CCD) array, a photodiode array, or other image sensing device that receives light via the lens and generates image data in response to the received image. Image sensor 64 obtains image information for the video frames that video capture device 60 is capturing. Image sensor 64 may also obtain image information such as, for example, auto focus, auto white balance, auto exposure, and other image functions.

One or more sensors 70 may provide sensor information regarding pressure applied to a surface on the video capture device 60. The surface may correspond to a display screen of the video capture device 60. The sensor information type and format that other sensors 70 provide may depend on the type of sensors available in video capture device 60. In one example, sensors 70 may include one or more pressure sensors, placed under a display panel of video capture device 60 (or the display of a computing device in which video capture device 60 resides). The one or more pressure sensor may be capable of determining when pressure is applied to the surface under which the one or more sensors are placed. A user may apply the pressure to the surface of video capture device 60, underneath which surface sensors 70 may be placed, while video capture device 60 may be capturing or playing back a video. When the pressure exceeds a certain minimum threshold, the one or more pressure sensors detect the pressure. In some examples, the one or more pressure sensors may detect the pressure and capture pressure measurements, which may be used to determine the amount and location of the applied pressure. In one example, a user may apply pressure during video capturing to indicate significance associated with the captured frames. In some examples, the user may indicate different levels of significance based on the amount of pressure the user applies, where the higher the amount of pressure applied to a frame, the higher level of significance associated with the frame. For example, the user may apply pressure to indicate frames that he/she considers significant or interesting moments in the video.

Processor 66 processes the obtained image information for each captured frame and stores the information in image storage device 68. Processor 66 may utilize the obtained image information for preliminary and subsequent processing. Processor 66 may also receive sensor information from sensors 70, e.g., pressure information, when the applied pressure exceeds a minimum threshold. Processor 66 executes algorithms that implement the techniques of this disclosure, as described in more detail below.

Processor 66 may comprise one or more processors capable of performing one or more of processing captured frames and performing preliminary processing. Processor 66 may provide captured frames and the corresponding information to codec 74, which may perform further image processing such as, encoding images; decoding encoded images for playback; and/or transmitting encoded images to another device for decoding and playback. Processor 66 may operate in conjunction with codec 74. Codec 74 and processor 66 may process and send captured frames to display 80 for playback, where display 80 may include video and audio output device, e.g., LCD screen, speakers, and the like.

Video capture device 60 may capture a video, and processor 66 may perform preliminary image processing on the captured video frames, and store the frames in storage 68. During preliminary processing, image information (e.g., brightness, exposure, and the like) may be determined and stored with each corresponding frame for subsequent processing. Additionally, during video capture, sensors 70 (e.g., one or more pressure sensors) may determine additional information such as, for example, whether pressure was applied to a frame or group of frames during video capture or video playback. In some examples, sensors 70 may also determine an amount and location of applied pressure associated with a frame for which pressure is detected (e.g., exceeds a minimum threshold) during video capture. Sensors 70 may send to processor 66 an indication that pressure was applied. In some examples, sensors 70 may send pressure amount and location information to processor 66 for storage or association with the corresponding frame. In one example, processor 66 may correlate the obtained pressure information with the corresponding frame or group of frames, such that, the correlation may be subsequently utilized to generate a data file with frame identifiers and the corresponding pressure information. For example, a pressure sensor may provide data for each frame indicating the amount and location of pressure applied to the surface under which the pressure sensor is located while video capture device 60 was capturing the frame. In one example, sensors 70 may provide pressure information for frames where the amount of applied pressure exceeds a minimum threshold. When sensors 70 provide no pressure information for a certain frame, the pressure associated with that frame may be set to 0.

In one example, processor 66 may indicate pressure associated with a frame by utilizing binary indications, where 1 may indicate pressure was applied to a frame and 0 to indicate that no pressure was applied to a frame. In another example, processor 66 may also provide an indication of the amount of pressure applied. For example, processor 66 may map the amount of pressure applied to a quantitative and unitless representation of the pressure. The quantitative representation may be a number in a range of numbers from 0 to N, where 0 corresponds to no applied pressure (or pressure below the minimum threshold) and N corresponds to an indication of pressure or a maximum amount of sensed pressure (or pressure above a maximum threshold), where N is 1 or more. As noted above, N may be 1 when processor 66 simply indicates pressure was applied to an associated frame or group of frames, regardless of the amount.

In one illustrative example, N may be 10, and each step between 0 and 10 may correspond to a range of pressure applied, so that pressure applied up to the minimum threshold corresponds to 0, minimum threshold to a first amount of pressure applied corresponds to 1, first amount of pressure applied to a second amount of pressure applied corresponds to 2, and so forth. While the examples herein discuss the techniques of this disclosure using the 0 to 10 range example, it should be understood that N can be any number. The quantitative representation may be a measure of good moment points (GMP), where a GMP value of 0 indicates a portion or frame of the video clip that the user does not consider significant and a GMP value of 10 indicates the user considers the associated portion or frame of the video clip of the highest significance. In one example, during video capturing, display 80 may display a pressure indicator that indicates the amount of pressure the user applies. For example, the pressure indicator may be a sliding bar scale with a sliding indicator button that slides from one end to another, according to the amount of pressure applied. The pressure indicator may, for example, be a number display that shows the corresponding number (e.g., 0 to 10) associated with the applied pressure or the actual amount of pressure applied.

Processor 66 may mark the frames with an indication of applied pressure. In one example, processor 66 may embed pressure information and other image information in a header for each captured frame. In this example, the pressure information may be encoded with the captured frames. The pressure information may be an indication that pressure was applied. In some examples, the pressure information may also include the amount of pressure sensed, or the mapped quantitative representation (e.g., 0 to 10). In other examples, the pressure information may also include the location of the pressure within the frame. In another example, processor 66 may generate a table of the captured frames, where the table may be populated with corresponding applied pressure information (e.g., amount of pressure applied, location of pressure, and the mapped quantitative representation of the applied pressure). In this example, processor 66 may populate the table with other information corresponding to the captured frames such as, for example, a timestamp or sequence identification number of each frame. In one example, processor 66 may increment a frame counter for every captured frame, and may include the counter value as an entry in the table of frame information along with the corresponding frame information (e.g., applied pressure, location of applied pressure, timestamp, and the like). In one example, where pressure information is the same for a group of consecutive frames (e.g., if the user applies pressure for 2 seconds, the applied pressure information will be the same for a range of 60 frames corresponding to a frame rate of 30 fps), the entries in the table may correspond to a range of frames. When the captured frames are encoded and transmitted, when applicable, the table of captured frames may be encoded and transmitted with the encoded frames. In another example, the pressure information may be encoded with the video clip as a separate track in a manner similar to encoding an audio track. In this example, the one or more sensors may obtain pressure information when the user applies pressure during video capture. For each frame, pressure information (e.g., raw pressure values or GMP values) may be stored with the frames in a separate track, e.g., in the same or similar manner that audio data is stored. A processor may subsequently retrieve the pressure information by separating the pressure information track from the audio and video track for further processing. The pressure information may be matched with the frames based on their order, as the pressure information track would have the same temporal order as the video.

Processor 66 may further analyze the applied pressure information. In one example, processor 66 may determine the applied pressure for the entire video clip. For example, for a 10 second video clip with 10 groups of frames (each group of frames corresponding to 1 second of video), the GMP values for each group of frames may be [0, 0, 0, 9, 9, 9, 5, 5, 5, 0]. In addition to marking the frames or groups of frames with pressure information (e.g., pressure was applied, pressure values, and the like), processor 66 may utilize the applied pressure information to characterize the video clip. For example, processor 66 may utilize the frame GMP values to determine an average GMP value for the video clip. In this manner, processor 66 determines a measure of significance of the video clip, and determines a GMP value for the video clip as a whole. In the example above, the video's average GMP value may be (9+9+9+5+5+5)/10=42/10 GMP/frame or 4.2 GMP/frame. The average GMP value may be stored in the video header or encoded with the video.

In one example, the user may capture multiple video clips that he/she may wish to play back and/or edit at a later time. Processor 66 may determine average GMP values for the captured video clips and mark each video clip with the corresponding average GMP value. Subsequently, when the user wishes to display the video clips to select one or more to play back or edit, the average GMP values associated with the video clip may be utilized to sort the video clips. For example, the video clips may be displayed in a decreasing average GMP value order, such that a video clip with the highest average GMP values is listed first. In this manner, video clips that the user considered to contain the most significant content are displayed ahead of video clips the user considered to contain less significant content.

In one example, the user may have captured multiple video clips, which may be subsequently displayed to the user as thumbnails, where each thumbnail represents a video clip. In this example, each one of the thumbnails may display a frame of the video clip, where the frame may correspond to a high GMP value. In another example, each one of the thumbnails may play back portions of the video corresponding to high GMP values. For example, if the GMP values range from 0 to 10, each of the thumbnails may play back portions or frames of the corresponding video marked at a GMP value of 5 or more. In this manner, the thumbnails corresponding to the video clips may be animated, e.g., acting as view windows for video for nearby frames in different areas of a video clip associated with a higher GMP value, where they show the most significant portions of the corresponding video clip, and the user can determine the content without having to play back the video clip.

Codec 74 may encode the captured frames by encoding the video frames along with information regarding applied pressure. For example, codec 74 may encode applied pressure information corresponding to a frame as meta data along with the frame, e.g., in the header of the frame. In another example, codec 74 may encode the table of applied pressure information to send with the encoded captured video, where the table of applied pressure information may include the applied pressure information (e.g., amount of pressure, GMP value, and/or location of applied pressure), as described above. Codec 74 may additionally encode the video's average GMP value.

In one example, codec 74 may encode frames using encoding quality that corresponds to the amount of pressure applied to respective frames. For example, a frame with a high GMP value may be encoded using better coding quality than a frame with a lower GMP value. For example, frames with higher GMP values may be encoded using a better quantization parameter (QP) value, or level of quantization, which controls the allocation of coding bits to the frame and hence the bit rate of the frame. The QP regulates the amount of detail preserved in an encoded image, by controlling the level of quantization applied to residual transform coefficients produced by a transform unit. Video encoders perform quantization residual values during encoding. The residual values may be discrete cosine transform (DCT) coefficient values representing a block of residual values representing residual distortion between an original block to be coded, e.g., a macroblock, and a predictive block, in a reference frame, used to code the block. In one example, when an encoder utilizes a very small QP value for higher quantization, a great amount of image detail is retained. However, using a very small QP value results in a higher encoding data rate. As the QP value increases, the video encoding rate drops, but some of the detail is lost, and the image may become more distorted.

According to techniques of this disclosure, frames with higher significance indicated by higher GMP values may be encoded using a smaller QP, and frames with lesser significance indicated by smaller GMP values may be encoded using a larger QP. The variation in QP over the range of GMP values may be set to a default mapping or may be selected by the user. It should be noted that in some encoding standards (e.g., H.264) a smaller QP corresponds to a greater amount of image detail retention, while in other encoding standards (e.g., MPEG 2) a smaller QP corresponds to a lesser image detail retention. The specifics of improvements to the encoding quality may therefore depend on the encoding standard.

In another example, codec 74 may apply the higher coding quality to residual transform coefficients for blocks at or near the location where the user applied the pressure. For example, while capturing a video of an event (e.g., a concert), the user may apply pressure to indicate significance of a frame, and may also apply the pressure at a location of even higher significance within the frame (e.g., the lead singer of a band), and may maintain the applied pressure and move his/her finger around following the movement of the location within the frame (e.g., following the lead singer as he/she moves around the stage). In this example, frames captured while the user applied a great amount of pressure may be encoded using higher coding quality, and within the frames, the location where the user applied the pressure may be encoded at an even higher coding quality relative to the coding quality of the frame.

For example, the frames with high GMP values may be encoded using a smaller QP than frames with smaller GMP values (or frames with applied pressure relative to frames with no applied pressure), and within the frames with high GMP values (or frames with applied pressure), an even smaller QP may be used to encode the portion of the frame corresponding to the location where the user applied the pressure. The user may select whether encoding the video should be also location-specific, in addition to GMP values, when encoding the frames. In some examples, the user may be able to indicate more than one location within a frame using multiple fingers, for example.

In other examples, other higher coding quality techniques may be applied to frames or portions of frames with applied pressure. In one example, the higher coding quality techniques may be applied to frames with applied pressure. In another example, different levels of high coding quality techniques may be applied to frames or portions of video clips based on the amount of applied pressure. Other example coding techniques that may be improved based on applied pressure, may be motion search, block size, and mode decisions (e.g., intra-frame and inter-frame motion detection and coding), and the like.

In one example, codec 74 may send the encoded video clip to storage 68. Processor 66 may control communication module 76, which may retrieve encoded video clips from storage 68 for transmission, when appropriate, to other devices. For example, the user may wish to transmit the video clip to another computing device for editing and/or display. While the decoding techniques below are discussed as being performed by codec 74 in video capture device 60, it should be understood that these techniques may be implemented by another device to which encoded video clips are transmitted from video capture device 60 via communication module 76.

Codec 74 may decode the captured encoded video for playback to the user or for editing by the user. Processor 66 may analyze the captured encoded video during the decoding process to determine which frames are marked as having pressure applied, the amount and/or location of the pressure applied, and the appropriate playback or display based on the applied pressure. In one example, where the user has captured several video clips, processor 66 may display thumbnails corresponding to the video clips in order of their average GMP values, which correspond to the average amount of applied pressure per frame or per time unit of video, as described above. In this manner, the user may be able to browse through the thumbnails of several video clips and select video clips to play back based on the average amount of significant moments the user indicated while capturing the video clip. For example, video clips with the highest average GMP values may be displayed on top of the list of user's video clips, therefore, allowing the user to select for playback videos that he/she considered to be of higher significance. In another example, each of the thumbnails may display a frame of the video clip, where the frame may correspond to a high GMP value. In another example, each one of the thumbnails may be animated and may play back portions of the video corresponding to high GMP values. For example, if the GMP values range from 0 to 10, each of the thumbnails may play back portions or frames of the corresponding video clip that the user marked at a GMP value of 5 or more. In this manner, the thumbnails may show the most significant portions of the corresponding video clip, and the user can determine the content of several video clips from the displayed corresponding thumbnails.

In one example, the user may select a video clip for playback. Codec 74 may send the decoded captured video for playback to the user on display 80. During playback, processor 66 may play back portions or frames of the video clip at playback speeds proportional to the GMP value of the frame, if the user selects the corresponding option. The user may select to display a captured video at speeds according to the applied pressure during video capture, where frames with larger applied pressure may correspond to portions of the video that the user thought most interesting, and may therefore want to play them back at a normal or slower than normal playback speed, whereas, portions with no or little applied pressure may be played at a faster than normal playback speed or skipped altogether. In one example, the playback speed may be proportional to the amount of pressure applied or the quantitative representation to which the amount of applied pressure is mapped (e.g., 0 to 10), where portions of the video may be played back at two or more different playback speeds, corresponding to two or more ranges of GMP values. For example, a first portion of the video with a low GMP value (e.g., 0, 1, 2, or 3) may be played back at a first playback speed that is 3 times the normal playback speed, a second portion of the video with medium GMP values (e.g., 4, 5, 6, or 7) may be played at a second playback speed that is 2 times the normal playback speed, and a third portion of the video with high GMP value (e.g., 8, 9, or 10) may be played at a third playback speed that is the same as normal playback speed. In one example, the user may select the number of playback speeds and the corresponding ranges or GMP values. In one example, the user may change the playback speed options during playback of the video clip by speeding up or slowing down the playback speed, pausing, skipping groups of frames, and the like.

In one example, the user may select a video clip for editing. Processor 66 may send decoded captured video for playback to the user on display 80, which may also display editing options associated with the video clip. In displaying the video clip for editing by the user, video frames or groups of frames of the video clip may be displayed on display 80 as images, e.g., thumbnails. In one example, the images of the video frames may be presented differently based on whether the user applied pressure exceeding the minimum threshold during capturing of the frames. For example, for frames for which the user applied pressure during capturing, representative images may be displayed larger than frames for which the user applied no pressure or pressure that did not exceed the minimum threshold. In one example, the size of the images representing the frames for which a user applied pressure exceeding the minimum threshold may be proportional to the amount of pressure the user applied. In this manner, frames for which the user applied pressure equal to or exceeding the maximum pressure threshold may be represented using the largest image relative to all other frames. In another example, frames or groups of frames (corresponding to 1 second portions of the video clip, for example) to which the user applied pressure may be displayed while frames or groups of frames to which the user applied no pressure or pressure that did not exceed the minimum threshold may not be displayed. As a result, if the user wishes to extract portions of the frames with the highest significance, for example, the user can easily identify the more significant frames. In another example, one of the images representing frames or groups of frames to which the user applied the highest amount of pressure may be used to display a thumbnail for the video clip when the user is browsing the different video clips. In this example, the user may more easily determine the content of the video clip, if one of the more significant frames is displayed, instead of the first or last frame, which may not be as significant to the user.

In another example, in displaying the video clip for editing by the user, the thumbnails or images representing video frames or groups of frames may be sorted and presented to the user on display 80 in an order corresponding to the significance of the frames, i.e., corresponding to the amount of pressure the user applied during capturing of the frames. In this example, thumbnails corresponding to frames or groups of frames with the highest amount of applied pressure may be displayed first, and in decreasing order to images corresponding to frames or groups of frames with the lowest amount of applied pressure or no applied pressure at all. In one example, the images may be sorted in order of amount of applied pressure on a first sorting level and in chronological order on a second sorting level. In this manner, frames or groups of frames with the same amount of applied pressure may be also sorted from first to last captured, or from last to first captured. In determining the chronological sorting order, processor 66 may utilize header information, when the pressure information is coded in the header of the frames or in the separate track, or the timestamp or identifier information, when pressure information is coded in a table or a separate file.

In determining the sorting order and/or the size of thumbnails representing the video frames, processor 66 may utilize the amount of pressure applied, if the value is encoded with the frames. In another example, where the encoded information include the GMP values, processor 66 may utilize the GMP values to determine the sorting order of the thumbnails representing the video frames, and/or the size of the displayed thumbnails. In some examples, processor 66 may utilize other methods for displaying thumbnails of the video frames or groups of frames based on applied pressure. For example, processor 66 may utilize highlighting (e.g., thumbnails of frames with greater pressure may be more highlighted relative to frames with less pressure), blinking or flashing (e.g., thumbnails of frames with greater pressure may blink slower or have a greater amount of flashing around the thumbnail relative to frames with less pressure), colored borders (e.g., thumbnails of frames with greater pressure may have brighter-colored borders relative to frames with less pressure), and so forth.

In one example, as discussed above, the captured video may be transferred to a separate device for further processing, display, and editing. For example, the user may connect video capture device 60 to another device, e.g., personal computer or a dedicated video editing and display device, which may perform at least a portion of the processing preformed by codec 74 and/or processor 66. The transferred video may include the captured frames and information regarding applied pressure, e.g., the table of captured frames, the separate track, or the information in the headers of the frames. The separate device may receive the captured video and pressure information indicating whether pressure was applied and/or the amount of pressure the user applied to the corresponding frame during video capturing. In one example, the separate device may analyze the information and process the video for display to the user for editing according to the techniques of this disclosure based on whether pressure was applied and/or the amount of applied pressure. In another example, the separate device may analyze the information, and play back the video to the user based on the applied pressure information as described above.

FIG. 1B is a block diagram illustrating an exemplary video system, in accordance with this disclosure. A user may utilize a video capture device 160 to capture video. Video capture device 160 may be a stand-alone video device or may be incorporated into a computing device (e.g., mobile phone, PDA, or the like). Video capture device 160 may be equipped with one or more pressure sensors 170 capable of detecting pressure above a minimum threshold P(n) applied during capture of a video frame F(n). One or more pressure sensors 170 may also be capable of determining the amount of pressure P(n). In one example, the one or more pressure sensors may also determine a location associated with the applied pressure. In one example, the one or more pressure sensors 170 may be located under a surface of the video capture device (e.g., screen of a display). During video capture, the user may apply pressure to indicate significance of a portion of video being captured (e.g., child's first steps or words).

As the user applies pressure, the one or more pressure sensors may determine the pressure P(n) for a corresponding frame F(n). Frame F(n) may represent a single frame or a group of frames corresponding to a time unit (e.g., 1 second) of captured video. In one example, the one or more pressure sensors (e.g., piezoelectric sensors or the like) may be placed under the surface of a screen of the video capture device. The one or more sensors may be placed under the surface of the screen at one or more known locations (e.g., under the center of the screen, under each corner of the screen, and so forth). By adding the one or more sensors under the surface of a touchscreen, when the user applies pressure to the screen, each of the one or more sensors may provide a reading of the force applied. The amount of force read by the one or more sensors may then be utilized to determine the amount of force applied in a direction perpendicular to the screen (e.g., a Z-axis component), in addition to a centroid of the force on the screen (e.g., X-axis and Y-axis components). For example, force applied in one of the corners of a screen, under which a plurality of sensors may be placed, may produce a greater force reading by force sensors closest to the location of the applied force than sensors placed farther away from the location of the applied force. In one example, four sensors may be used, one in each corner of the screen. In other examples, fewer or more sensors may be used, and may be arranged in different arrangements, if desired. The force sensors may be capacitive force sensors, resistive force sensors, piezoelectric force sensors, and the like. In some examples, the one or more sensors may measure the applied force in various units of measure. For example, the applied force may be measured in terms of capacitance, resistance, voltage or current levels, or other electrical parameters, or corresponding digital values. Examples of the operation of touch screens with one or more sensors are described in U.S. patent application Ser. No. 12/939,078 filed on Nov. 3, 2010 and entitled “FORCE SENSING TOUCH SCREEN,” which is incorporated herein in its entirety.

When a user applies pressure to the screen, the one or more sensors create an electric potential, which can be measured. In one example, the measured electric potential is proportional to the amount of applied pressure, and the sensor output can be measured with an analog-to-digital converter. In another example, the force may be determined by measuring dynamic changes in the voltage level. In another example, the measured electric potential may be directly translated into GMP values. P(n) may be a measured voltage value, a raw pressure value, or a GMP value, for example. As noted above, the one or more sensors may make current, voltage, or other electrical measurements to determine the amount of force a user applies to the screen.

The one or more sensors 170 may send the amount of pressure P(n) in parallel with the corresponding frame F(n) to processor 166. Pressure P(n) measurements may be made every M^{th} frame, instead of every frame and the measured P(n) may be applicable to M frames starting from the one when pressure measurement is made. Therefore, pressure measurements may be determined at P(0+n*M), where n=0, 1, 2, 3, etc. For example, pressure P(n) may be measured once every second, which for a video clip captured at 30 fps, may be obtained every 30 frames. In this example, P(0) may be obtained at the beginning of video capture and associated with the first 30 frames (F(1)-F(30)), P(10) may be obtained at the 11^{th} second of the video clip, and associated with frames F(301)-F(330), and so forth.

Processor 166 may perform image processing on the captured images and forward the frames along with pressure information to frame marking unit 172. In some examples, processor 166 may convert the pressure information to a quantitative and unitless representation, e.g., 0 to N, where N is 1 or more. The quantitative and unitless representation of the pressure information may be a GMP value, and may be a unitless quantification of the significance of a frame or a group of frames based on the amount of pressure the user applied during capturing of the frame or the group of frames. In the simplest example, where N is 1, the GMP value indicates whether a user applied pressure or did not apply pressure during video capturing. In other examples, where N is greater than 1, the GMP value indicates 3 or more different levels of significance to the user corresponding to no applied pressure, and 2 or more different levels of applied pressure.

Frame marking unit 172 may further process the frame and the pressure information for the captured frames and mark the frames accordingly. In one example, frame marking unit 172 may modify the header of each frame to include detected pressure information. In another example, frame marking unit 172 may generate a separate track (e.g., similar to an audio track) or a separate file that contains the detected pressure information, as described above. Frame marking unit 172 may send the marked frames (frames with modified headers or frames and separate file) to encoding unit 174. In some examples, frame marking unit 172 may determine an average GMP value for the captured video, as discussed above. In this example, frame marking unit 172 may send the average GMP value to encoding unit 174 to encode with the video clip.

Encoding unit 174 may be part of a codec. Encoding unit 174 may encode the captured video, which may include frames with the modified headers or the separate files, which may be also encoded with the video. In some examples, during encoding, encoding unit 174 may utilize different coding qualities for encoding frames based on whether a frame is marked as having pressure applied during capturing. In one example, the coding quality for frames with applied pressure may be higher relative to frame with no applied pressure. In another example, different levels of coding quality may be utilized corresponding to different amounts of applied pressure, as described above. Encoding unit 174 may output encoded frames F′(n), which include marking information associated with the applied pressure, in frame headers or as a separate file/track. Marking information may indicate the amount of pressure applied, which may be an indication that pressure was applied, raw pressure data, or GMP values.

The encoded frames F′(n) may then be sent to a video display device 190. Video display device 190 may be part of the same device as video capture device 160 or may be in a separate device. Video display device 190 may be used for playback and/or editing of encoded captured video F′(n). Video display device 190 may include decoding unit 178, which may decode F′(n) for playback and/or editing. Decoding unit 178 may decode the encoded frames, and extract marking information from the header of the frames or from the separate file. Processor 186 may process the decoded frames and marking information and send to display unit 180 for playback and/or editing. In one example, where marking information comprises raw pressure values, processor 186 may determine corresponding GMP values or may utilize the raw pressure values in processing the decoded video frames for playback and/or editing. Processor 186 may process decoded frames for display to the user via display 180.

In one example, if the user indicates editing mode, processor 186 may utilize editing preferences for display based on the marking information. For example, frames or groups of frames corresponding to marking information indicating applied pressure may be displayed differently relative to frames or portions corresponding to no applied pressure. In one example, frames with indicated pressure may be displayed using larger images (e.g., thumbnails, icons, or the like) relative to frames with no indicated pressure. In another example, frames with indicated pressure may be displayed with a different visual indication (e.g., color, outline, flashing, highlighting, tag, arrow, or the like) relative to frames with no indicated pressure. In these examples, the different display characteristics may be varied according to the amount of pressure applied for frames with indicated pressure. In yet another example, frames may be sorted in an increasing or decreasing order that corresponds to the amount of pressure applied. In one example, the user may select a displayed frame or group of frames and play back a portion associated with the frame (e.g., all frames with the same display characteristics) or play back the captured video clip beginning at the selected frame or play back frames with the same indicated applied pressure.

In another example, if the user indicates playback mode, processor 186 may utilize playback preferences for playback based on the marking information. For example, frames or portions of the video corresponding to marking information indicating applied pressure may be played back at a different playback speed relative to frames or portions of the video with no applied pressure. In one example, the frames or groups of frames with applied pressure may be played back at a slower playback speed. In another example, the frames or portions with applied pressure may be played at different playback speeds according to the amount of applied pressure. In this manner, frames or groups of frames indicated with the highest amount of pressure or highest GMP values may be played back at the slowest playback speeds (e.g., normal playback speed or slow motion), and frames with smaller amount of pressure or smaller GMP values may be played back at faster playback speeds relative to the playback speed of the highest pressure portions (e.g., 2×, 3×, 4× slowest playback speed).

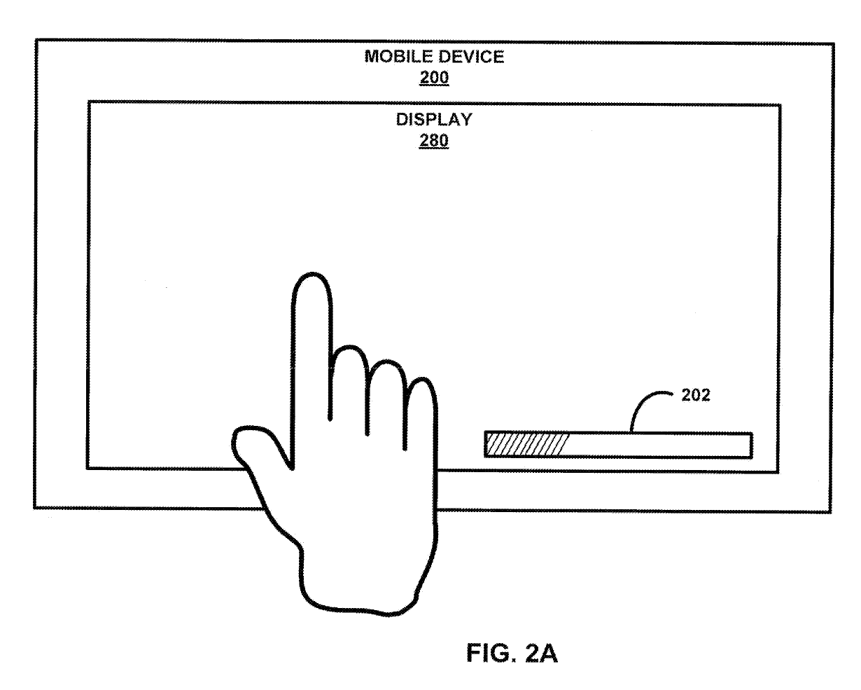

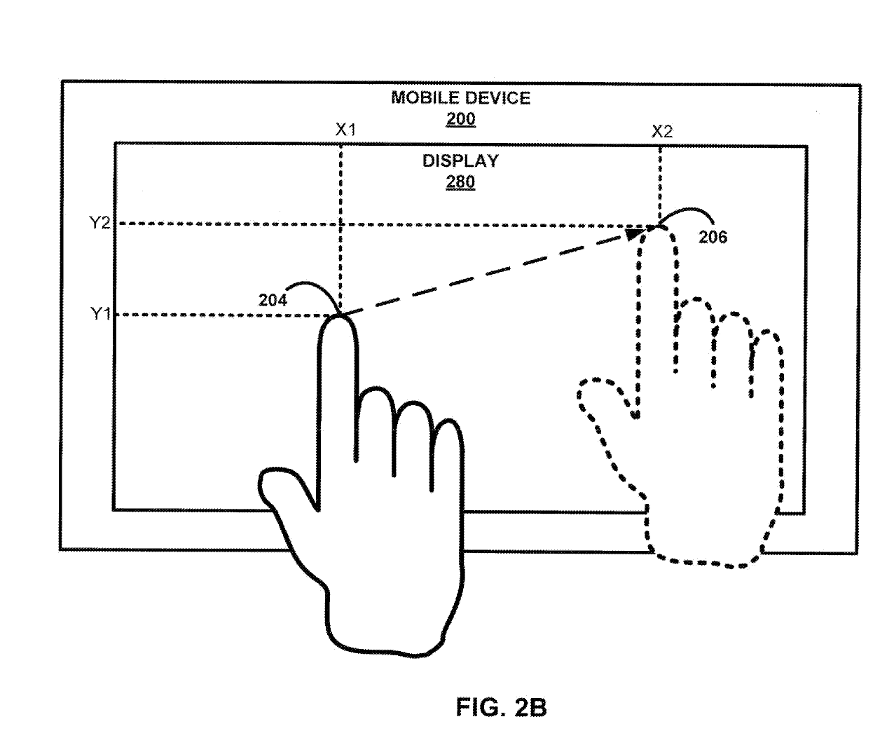

FIGS. 2A-2B illustrate exemplary user interaction with a mobile device, in accordance with this disclosure. In this example, a user may utilize a video capture device (e.g., video capture device 60 of FIG. 1A) that is incorporated into mobile device 200. The user may run a video capturing application associated with the video capture device and start capturing a video. While capturing the video, an event may occur in the scene that the user is capturing that may be of significance to the user, and the user may wish to indicate the significance of the event (e.g., a band performing user's favorite song, a child walking or talking for the first time, and the like). As shown in FIG. 2A, the user may apply pressure to a surface associated with one or more pressure sensors to indicate significance of the frames being captured. In this example, the surface may be a screen of display 280 of mobile device 200. The one or more pressure sensors (not shown) may detect the applied pressure if it is above a minimum threshold, and sense the amount of pressure applied (e.g., in force per unit area).

In one example, the user may apply more pressure to some frames or portions of the video to indicate more significance relative to other frames or portions, to which the user may apply less pressure or no pressure at all. In some examples, an indicator 202 may be displayed on display 280 to indicate the amount of pressure applied. In this example, the indicator may display the amount of pressure applied relative to a range of pressure from minimum threshold pressure to maximum pressure, and where the shaded area indicates the amount of pressure applied relative to the available range of pressure. In other examples, the system may keep track of pressure and no pressure, and an indicator may simply indicate pressure versus no pressure without indicating the amount.

In other examples, the indicator may be a unitless number indicating the amount of pressure applied on a known scale (e.g., from 0 to 10). In other examples, a GMP indicator may be displayed on the screen, as a sliding bar, for example. The user may be able to change GMP values for portions of the video during video capture or video display, by changing the GMP value. In this example, the user may be able to change the GMP values without having to apply pressure at all.

In addition to sensing the amount of pressure the user applies to the screen of display 280, the one or more pressure sensors may also provide information, which a processor may utilize to determine a location of the applied pressure (e.g., coordinates on the surface where the user applies the pressure). For example, a user may indicate significance of a specific portion of a captured video. The user may also want to indicate a location within the display of the specific portion of the subject of interest, e.g., a lead singer of a band during a performance interesting to the user. As illustrated in FIG. 2B, the user may initially apply pressure to display 280 at a location 204, where the subject may be initially located within the screen, and as the subject moves to a new location, 206, the user, while applying pressure to display 280 may move his/her finger. In this manner, the amount of pressure and the location of the pressure may be determined by the pressure sensors associated with mobile device 200 and display 280.

In marking the frames, a processor may include amount of pressure information and location information. In this example, for a first portion or frame, the marking information may include the amount of pressure and the associated location (X1,Y1), and for a second portion or frame corresponding to the user moving the location of pressure to new location 206, the marking information may include the amount of pressure applied and the associated location (X2,Y2). The location information may include the coordinates, (X, Y) as the center of a number of blocks around the center coordinates. In one example, the number of blocks around the center coordinates may correspond to the area covered by user's finger. In another example, the number of block around the center coordinates may be set by default or by the user. In some systems that support location-specific encoding, frames with applied pressure may be encoded using coding quality corresponding to the amount of applied pressure, and additionally, the location associated with the pressure may be encoded at a better coding quality than the rest of the frame.

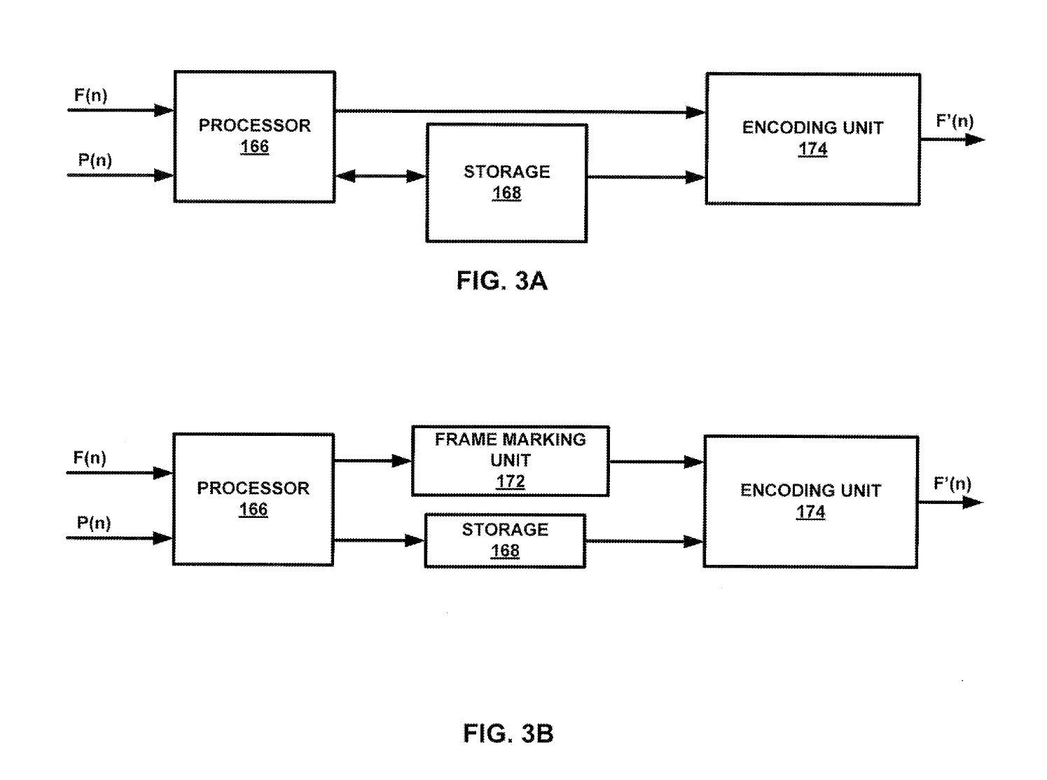

FIGS. 3A-3B are block diagrams illustrating exemplary encoding of pressure information with video content. In the example of FIG. 3A, processor 166 may receive frame information F(n), which may include frame sequence information such as, for example, a timestamp or an identification of the associated frame. Processor 166 may also receive pressure information P(n), which may be an amount of pressure associated with frame F(n), as detected by one or more pressure sensors of a video capture device used to capture frame F(n). The video capture device may be a stand-alone video device or may be incorporated into another device, and may include processor 166, storage 168, and encoding unit 174, which may be part of a codec. Processor 166 may perform some image processing on the frames and store processed frames in storage 168. Processor 166 may also send information to encoding unit 174 for use during video encoding, including frame information and frame pressure information. In one example, processor 166 may send raw pressure information to encoding unit 174. In another example, processor 166 may map the pressure information into representative unitless quantities or GMP values, ranging from 0 to N, where N may be 1 or higher, as explained above.

Encoding unit 174 may retrieve the captured processed frames from storage 168, and may utilize the frame information and pressure information received from processor 166 to encode the frames with pressure information. In this example, encoding unit 174 may embed the pressure information in the frames before encoding the frames. For example, encoding unit 174 may modify the headers of the frames to add the pressure information (raw pressure amount or mapped pressure values) to the headers of the corresponding frames. After modifying the frames with the pressure information, encoding unit 174 may encode the modified frames in accordance with the techniques of this disclosure.

In the example of FIG. 3B, processor 166 may receive frame information F(n), which may include frame sequence information such as, for example, a timestamp or an identification of the associated frame. Processor 166 may also receive pressure information P(n), which may be an amount of pressure associated with frame F(n), as detected by one or more pressure sensors of a video capture device used to capture frame F(n). The video capture device may be a stand-alone video device or may be incorporated into another device, and may include processor 166, frame marking unit 172, storage unit 168, and encoding unit 174, which may be part of a codec. Processor 166 may perform some image processing on the frames and store processed frames in storage 168. Processor 166 may also send frame information and frame pressure information to frame marking unit 172.

Frame marking unit 172 may utilize the frame information and the frame pressure information to generate a data file or a table that includes the frame pressure information and the corresponding frame identification based on the frame information. The frame identification may be a counter indicating the position of the frame in the sequence of captured frame, or a timestamp indicating the time of frame capture, which may be also included in the frame itself. In one example, processor 166 may send raw pressure information to frame marking unit 172. In another example, processor 366 may map the pressure information into representative unitless quantities or GMP values, ranging from 0 to N, where N may be 1 or higher, as explained above, then send the mapped values to frame marking unit 172. Frame marking unit then sends the generated file or table to encoding unit 174.

Encoding unit 174 may retrieve the captured processed frames from storage 168. In this example, encoding unit 174 may encode the video frames in accordance with the techniques of this disclosure. In one example, encoding unit 174 may encode the generated file or table of pressure information as an additional track with the encoded video, similar to encoding an audio track, for example. In another example, encoding unit 174 may encode the generated file or table of pressure information separately to store or transmit with the encoded video frames, such that, when a user wishes to decode the encoded video for display or playback, both the encoded frames and the encoded file or table of pressure information may be also decoded and used in accordance with techniques of this disclosure.

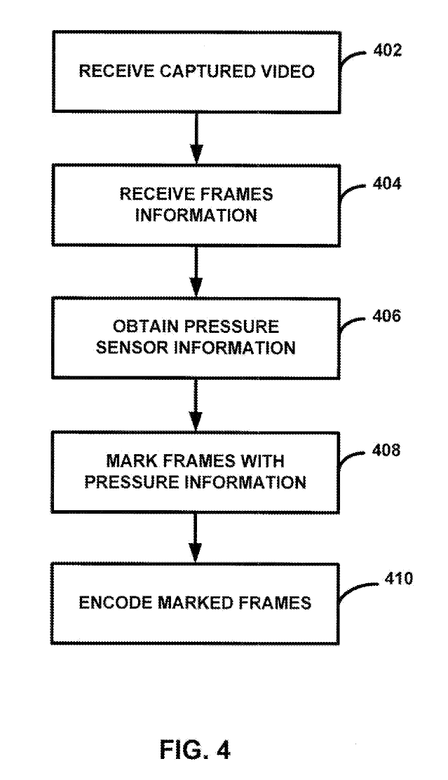

FIG. 4 is a flow diagram illustrating video capturing and marking using techniques of this disclosure. The process of FIG. 4 may be performed in a video system, e.g., video capture device 60 of FIG. 1A. As shown in FIG. 4, a video capture device may be capturing video and a processor may receive video frames (402). In addition to image data, the processor may receive frame information such as, for example, sequence identification associated with the position of the frame within the video clip and/or timestamp information (404). As video capture device captures the frames, the user may apply pressure to the frames of the video during video capture to indicate significance associated with the frames being captured. The video capture device may include one or more sensors placed under the surface to which the user applies the pressure. The one or more sensors obtain the pressure information (406). In one example, the surface may be a display screen of the video capture device. The one or more pressure sensors may sense the applied pressure when the user applies an amount of pressure that exceeds a minimum threshold pressure.

The pressure information may include an amount of applied pressure (e.g., force per unit area). In some examples, the pressure information may also include location information, e.g., coordinates on the surface where the user applied the pressure. The amount of pressure the user applies may vary according to how significant the user perceives a frame or portion of the video to be. For example, the user may apply more pressure to portions of the video that he/she perceives to be more significant than other portions. In one example, the display screen may display a visual indicator of the detected pressure. For example, a scale may be displayed, where an indicator button may move from one end of the scale to the other end in response to going from no pressure to maximum applied pressure. In another example, the visual indicator may be a numeric indicator corresponding to the amount of pressure applied, where the numbers may range from 0 to N, and N can be 1 or more. In this example, where N is 1, the indicator indicates when pressure is applied with 1, and no pressure application with 0. In other examples, where N is 2 or more, 0 may indicate no application of pressure and other values indicate different amounts of applied pressure.

Using the pressure sensor information, which may be obtained for each frame, the processor may mark frames using the pressure information (408). In marking the frames, the processor may correlate the pressure information with the appropriate frames using the frame information, then mark the frames with the pressure information. In one example, marking the frames may include modifying the frame header to include the pressure information. In another example, marking the frames may include generating a data file or table that includes the pressure information with the corresponding frame identification information (e.g., frame sequence identification or frame timestamp). The pressure information may be raw pressure information (e.g., force per area unit) or may be mapped pressure information. In one example, the processor may map the detected pressure information into two or more significance levels.

The significance levels may correspond to a unitless representative numbers from 0 to N, for example, where N may be 1 or more. For example, N may be 10, and the significance levels may correspond to ranges of amount of pressure applied, where 0 corresponds to pressure below a certain minimum threshold, 10 corresponds to pressure above a maximum threshold, and the amount of pressure from the minimum threshold to the maximum threshold may be divided into 9 different levels corresponding to 1 to 9. The number of significance levels may vary depending on the system design or a user selection. The significance levels may be referred to as GMP (good moment point) values, as the user may apply pressure during portions of the video that he/she may consider significant moments (e.g., an exciting part of a concert, a child's first steps, and the like).

In some examples, the user may apply pressure at a specific location corresponding to a particularly interesting part of the frame (e.g., band's lead singer's face), and may move the location of pressure application around as that part of the frame moves around the screen during video capturing. In other examples, the user may apply pressure at more than one location, if there is more than one interesting part within the frame. In this example, the pressure information may also include the pressure location information and may be included with the pressure information in the header or the separate data file or table.

In one example, the processor may utilize the pressure information for all the frames of a video clip to determine an average measure of pressure associated with the entire captured video clip. For example, using the GMP values for all the frames of the captured video, the processor may determine an average GMP value, which includes 0 for frames for which the user applied no pressure or applied pressure below the minimum threshold. For example, a captured video average GMP value may be expressed in GMP value per frame (or per second).

In one example, average GMP values for several captured video clips may be utilized to display the video clips to the user in order of increasing or decreasing average GMP value. In this manner, the average GMP value for a video clip may indicate the average significance associated with the video clip. When selecting one of several video clips to play back, the user may want to play back video clips that he/she thought had the most significant or interesting portions, and therefore, the user may select to play back video clips with the highest average GMP value.

When the video frames of a captured video have been marked, the marked video frames may be encoded by a codec (410). Encoding the marked frames may include encoding the frames with the modified headers, encoding the captured video clip with the separate data file similarly to encoding an audio track, for example, or encoding the captured video clip and the table of applied pressure information. In one example, encoding the captured video may also include encoding the header of the video clip that includes an average GMP value for the video clip.

In one example, during encoding, the codec may encode frames using a coding quality based on the amount of applied pressure associated with the frames. For example, frames marked as having applied pressure may be encoded using a better coding quality than frames as not having applied pressure. In another example, different coding qualities may be used to encode frames with different amounts of applied pressure, frames with more applied pressure may be encoded using higher coding quality than frames with less applied pressure, as described in more detail above. In another example, within marked frames, the location where the pressure is applied may be also defined as a region of higher significance within the frame, and encoded using higher coding quality than the remainder of the frame. Whether coding quality is location-specific may be determined by default system settings or by user selection. The encoded video along with the pressure information may then be stored or transmitted to another device, until the user decides to edit or play back the captured video.

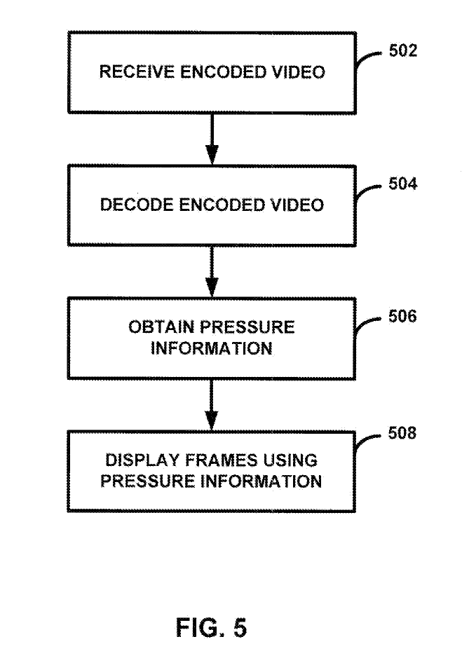

FIG. 5 is a flow diagram illustrating video display using techniques of this disclosure. The process of FIG. 5 may be performed in a video display system, e.g., video capture device 60 of FIG. 1A, or another computing device to which encoded video may be transmitted from the video capture device for display and/or playback. As shown in FIG. 5, the video display system may receive the encoded video (502), which may have been captured and encoded as described with reference with FIG. 4. A decoder (or codec) in the video display system may decode the encoded video (504). In one example, the decoding may result in obtaining the video frames and any other encoded data (e.g., data files or tables) that may contain frame pressure information. In another example, the decoding may result in obtaining the video frames, which may include pressure information in the headers of the frames. A processor may process the decoded frames and any other data (e.g., data file or table) to obtain the pressure information associated with the decoded frames (506). The pressure information may be raw pressure amounts (e.g., force per unit area) or mapped to GMP values, as discussed above. If the pressure information is raw, the processor may map the pressure information to GMP values. The processor may utilize the applied pressure information to display the frames of the captured video to the user (508).

In one example, the frames may be displayed as images (e.g., thumbnails or icons). The thumbnails for frames with detected applied pressure may be displayed differently from thumbnails for frames with no detected applied pressure. For example, the thumbnails for frames with detected applied pressure may have an indication, such as, a tag on the corner of the thumbnail, a framing around the thumbnail, flashing, differently-colored edges, highlighting, or the like. In another example, the thumbnails for frames with detected applied pressure may be displayed in a different size than the thumbnails for frames with no detected applied pressure. In this example, the size of the thumbnails for the frames with detected applied pressure may also vary according to the amount of pressure applied. For example, frames with a greater amount of applied pressure may be represented using a larger thumbnail relative to frame with a smaller amount of applied pressure. In one example, thumbnails may represent groups of frames, where a frame may represent a group of frames, and the group of frames may represent a time frame of the video clip, e.g., 1 second, which would correspond to 30 frames in a system with a frame rate of 30 fps. In other examples, a group of frames may correspond to longer or shorter amounts of time of a video clip, but may include all consecutive frames with the same amount of applied pressure. In this example, the user may apply the same amount of pressure for 5 consecutive seconds during video capture, and the frames corresponding to the 5 seconds may be represented with one thumbnail during display.

In another example, the thumbnails for all frames may be sorted according to the amount of applied pressure. For example, the thumbnails for frames with larger amounts of applied pressure may be displayed first, and in order or decreasing amount of applied pressure, to frames with no detected applied pressure displayed at the end. In this example, frames with the same amount of detected applied pressure may be displayed in chronological order, where frames captured earlier in the video clip may be displayed ahead of frames captured later in the video clip. The sorting order of the thumbnails may be set by default or selected by the user. Using the displayed images, the user may select video frames for editing or for playback purposes, based on the significance of the images as indicated by its display.

In one example, the user may select displayed frames or groups of frames for editing purposes. Editing may include, for example, deleting or moving frames or groups of frames, applying transitions between frames or groups of frames, applying effects to portions of the video clip, applying graphics, copying or extracting portions of the video clip to create a new video clip, and the like. The user may select individual frames or groups of frames based on significance as indicated by the different display indicators. The user may also apply certain editing to a set of frames by selecting the corresponding thumbnails.

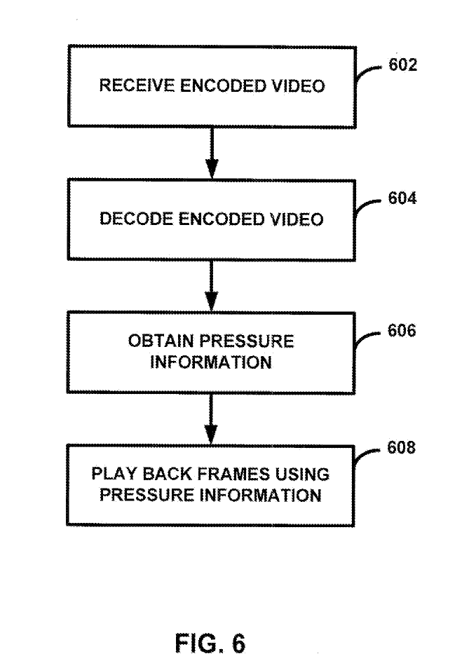

FIG. 6 is a flow diagram illustrating video playback using techniques of this disclosure. The process of FIG. 6 may be performed in a video display system, e.g., video capture device 60 of FIG. 1A, or another computing device to which encoded video may be transmitted from the video capture device for display and/or playback. The process of FIG. 6 may also be similar to that of FIG. 5, where the video display system may receive the encoded video (602). A decoder (or codec) in the video display system may decode the encoded video (604). The decoding may result in obtaining the video frames frame pressure information, in the headers of the frames or as separate data files or tables. A processor may process the decoded frames and any other data (e.g., data file or table) to obtain the pressure information associated with the decoded frames (606). The processor may then utilize the applied pressure information to play back the frames of the captured video to the user (608).

In one example, the processor may play back portions or frames with detected applied pressure at a different playback speed from portions or frames with no detected applied pressure. For example, the processor may play back frames with detected applied pressure at a slower playback speed relative to frames with no detected applied pressure, therefore, allowing the user to watch the portions of the captured video that he/she considered more interesting. In another example, the processor may play back the frames at several playback speeds based on the amount of applied pressure associated with the frames. For example, frames with very high applied pressure may be played back at a slowest playback speed relative to other frames, frames with high applied pressure may be played back at twice the playback speed, frames with medium applied pressure may be played back at three time the playback speed, and so forth. The number of play back speeds may depend on the system design, default system options, or user selection.

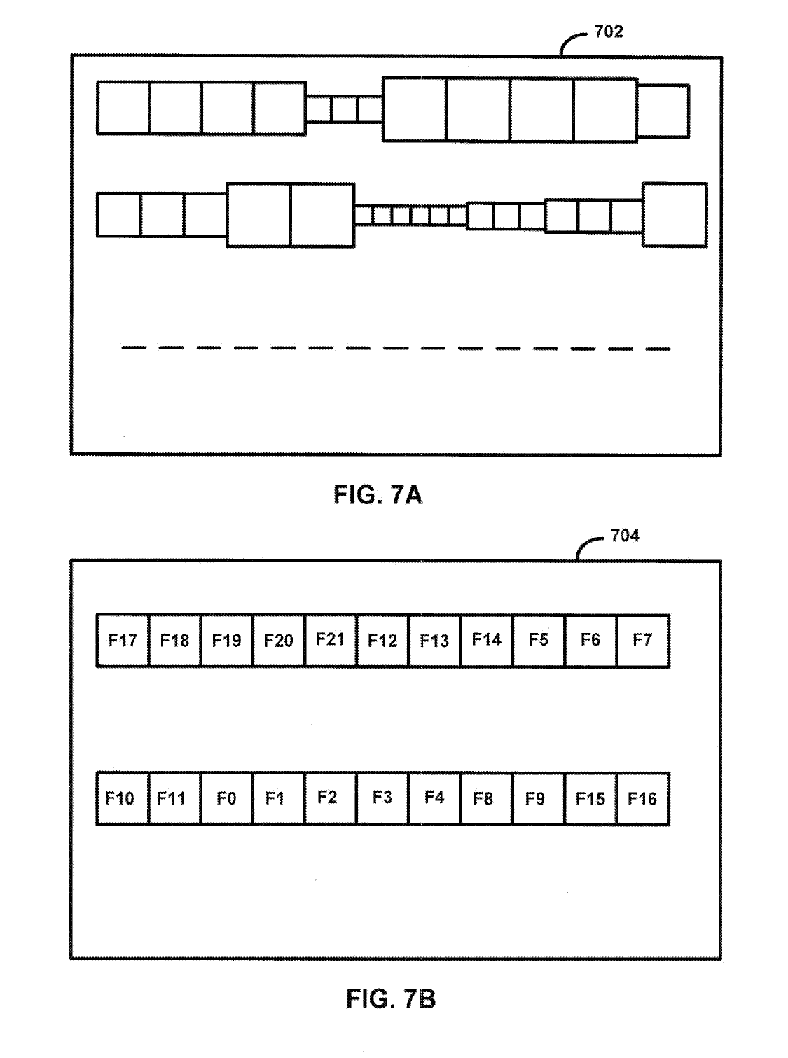

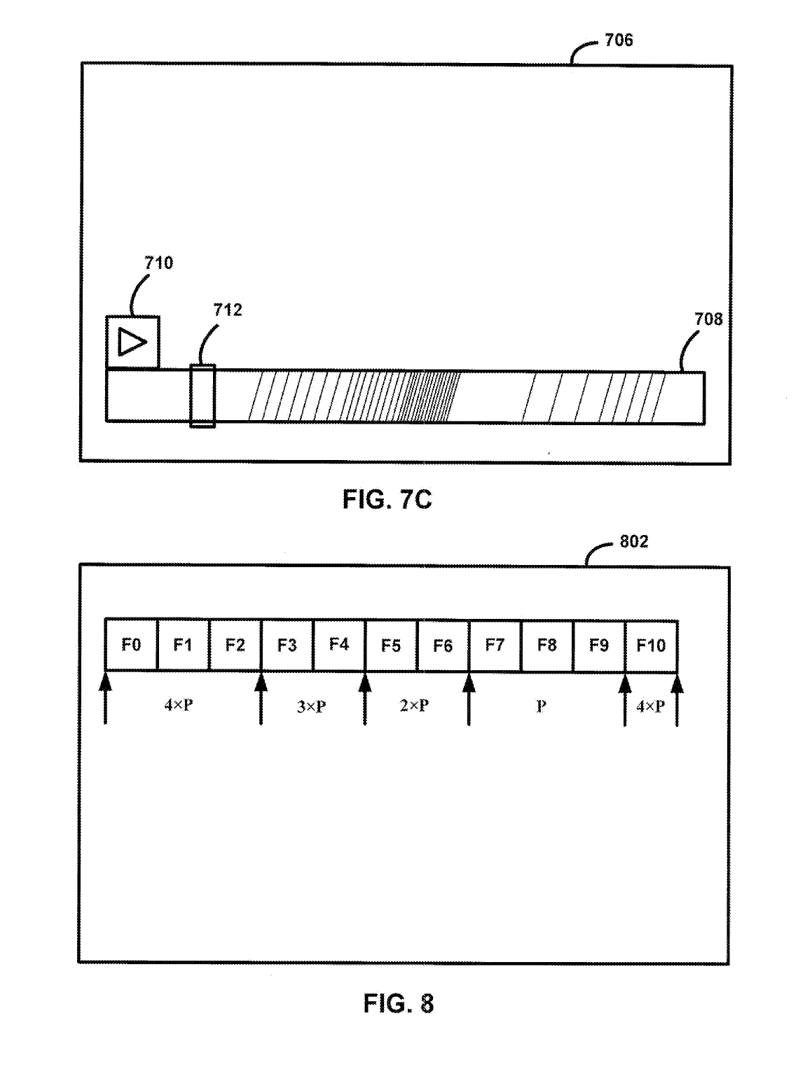

FIGS. 7A-7C illustrate exemplary screen shots of a computing device showing examples of video display, in accordance with this disclosure. As FIG. 7A shows, display 702 of a computing device may display images representing frames or portions of video using size of the image as an indication of the amount of pressure the user applied during video capturing to indicate significance of a frame or portion of video. In this example, and all subsequent examples, a single image (e.g., thumbnail or icon) may represent a frame or group of frames. The size of the images may be proportional to the amount of pressure the user applied during video capture of the corresponding frames, where the largest thumbnails represent frames corresponding to the maximum pressure and the smallest represent frames corresponding to pressure less than the minimum threshold. The images may be displayed using two or more different sizes, where the number of different sizes may be set by default or selected by the user. The user may be able to select an image based on the size, and may be able to indicate the desire to display all the frames or portions corresponding to one size. For example, the user may select to playback or edit all the frame or portions corresponding to the largest size image, i.e., corresponding to the highest significance level based on the highest amount of applied pressure.

As FIG. 7B shows, display 704 of a computing device may display images representing frames or portions of video using sorting order as an indication of the amount of pressure the user applied during video capturing. The images may be sorted in order from most significant frames or portions to least significant, according to the amount of pressure the user applied. Frames or portions of video with the same amount of pressure may be displayed in chronological order within the sub group with the same amount of pressure. In this example, the frames or portions may be sorted in decreasing amount of applied pressure order. For example, frames or portions F17-F21 may correspond to the highest amount of applied pressure relative to the other frames or portions, frames or portions F12-F14 may correspond to the next amount of applied pressure, frames or portions F5-7 and F10-F11 may correspond to the next amount of applied pressure, and frames or portions F0-F4, F8-F9, and F15-F16 may correspond to no applied pressure. In this example, there may be 4 different levels of applied pressure. In other examples, more or fewer levels may be utilized.

FIG. 7C illustrates display 706 of a computing device to display a scroll bar 708 representing the length of the captured video. The user may use play button 710 to play back the captured video. Scroll bar 708 may display an indication of portions of the captured video that the user indicated as interesting or significant by applying pressure during video capture. In this example, the indication may be illustrated using shading or coloring over portions of scroll bar 708. In this example, the more densely-shaded a section is, the more significant or more applied pressure it indicates. If the user does not want to play back the portions that he/she did not indicate as significant, the user may move selector 712 to the desired portion and start playback at that portion. Other techniques may be utilized to indicate on the scroll bar the portions with the different pressure amounts, e.g., different colors, highlighting, arrows, numbers (e.g., GMP values), and the like.

While the examples of FIGS. 7A-7C illustrate three examples of displaying indications of frames to which pressure was applied and/or indications of the amount of pressure applied to frames or portions of captured video, it should be understood that the indicative displaying techniques are not limited to these examples. Other display indications may be utilized to distinguish for the user frames or portions with different amounts of applied pressure and therefore, different significance levels. Other indications may include color coding, flashing, numbers indicative of GMP values, boxes around images for portions with the same amount of applied pressure, and so forth.

FIG. 8 illustrates an exemplary screen shot 802 of a computing device showing an example playback of a video, in accordance with this disclosure. In this example, the captured video may include frames or portions F0-F10, where each frame or portion represents a section of the captured video. A user capturing the video may have applied different amounts of pressure during video capture, indicating a different significance associated with each frame or portion. During playback, each frame or portion may be displayed at a play back speed that corresponds to the significance associated with the frame or portion as indicated by the amount of applied pressure. In this example, there user may have indicated 4 different levels of significance, which may correspond to different ranges of applied pressure. The frames with the most significance may be played back at a playback speed P, which may be normal speed or a slower speed, as indicated by the user, if the user wants to see the more significant portions in slow motion. The frames or portions corresponding to the next two of levels of significance may be played back at faster speeds, e.g., 2×P and 3×P, and the frames or portions corresponding to no applied pressure (or pressure below a minimum threshold) may be played back at the fastest speed, e.g., 4×P. In some example, portions with no applied pressure may be also skipped. The playback options may be set to a default setting or may be based on user selection.

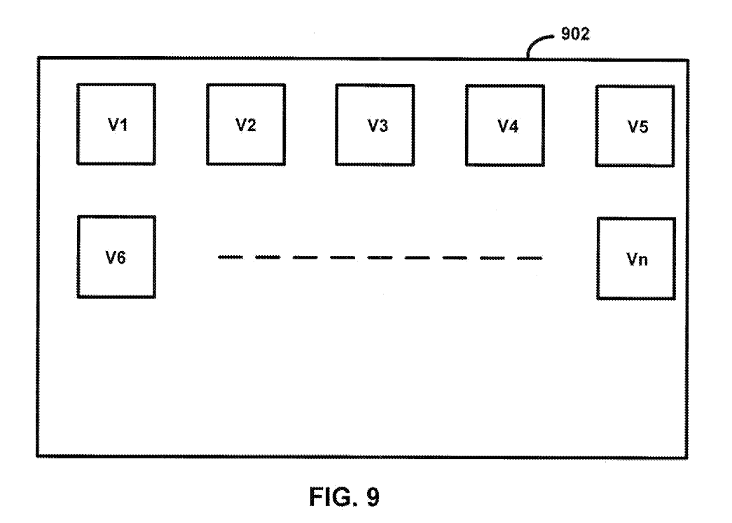

FIG. 9 illustrates an exemplary screen shot 902 of a computing device showing an example display of video clips, in accordance with this disclosure. As FIG. 9 shows, display 902 may display images (e.g., thumbnails) representing multiple video clips V1-Vn, that the user had previously captured. The user may have applied pressure during capture or play back of a video clip to indicate significance of certain portions of the video clip. The average significance of a video clip may be based on the number of frames corresponding to pressure applied by the user. For example, where the amount of pressure applied is mapped to a corresponding GMP value, the average GMP of a video clip may be determined, as discussed above. In other examples, the average significance may be determined based on raw pressure amounts. In one example, the video clips may be displayed in an order corresponding to their associated average significance (e.g., increasing or decreasing average GMP values). In this manner, the user may be able to browse through the thumbnails of several video clips to play back based on how significant the video clips are. In one example, the thumbnail may be an image corresponding to a frame or portion of the video clip with a high significance indication (e.g., high GMP value), and as a result, the user may have better knowledge of the content of the video clip than if the first or last frame are used as the thumbnail image. In another example, the thumbnail may be animated by playing back portions of the corresponding video clip corresponding to high GMP values or pressure amounts. For example, if the GMP values range from 0 to 10, each of the thumbnails may play back portions of the corresponding video clip that the user marked at a GMP value of 5 or more. In this manner, the thumbnail may show the most significant portions of the corresponding video clip, and the user can determine the content of several video clips from the animated thumbnails. The user may then select for play back a video clip that has the content he/she wants to play back, for example, to show a friend.

While this discussion explores techniques of this disclosure in terms of force applied to a surface of a computing device to mark frames or portions of a video clip, other techniques may be utilized to mark video frames or portions. In one example, the hover technique may be utilized, where a user may hold a finger above a surface (e.g., the display screen) and move it closer to or farther away from the surface to indicate significance of a video frame or portion. In this example, the finger or hand may be detected above a screen (e.g., LCD) using capacitive proximity methods. In one example, the farther away the finger hovers above the surface, the more significant the video frame or portion, and the higher the assigned GMP value with that video frame or portion of the clip. Examples of the techniques for interacting with touch screens using the hovering method are described in detail in U.S. patent application Ser. No. 12/862,066 filed on Aug. 24, 2010 and entitled “METHODS AND APPARATUS FOR INTERACTING WITH AN ELECTRONIC DEVICE APPLICATION BY MOVING AN OBJECT IN THE AIR OVER AN ELECTRONIC DEVICE DISPLAY,” which is incorporated herein in its entirety.

In other examples, the computing device may be designed such that pressure may be applied to other portions of the computing device than the screen. For example, sensors may be embedded into the outer shell of the computing device (e.g., edges where the user may hold the device). The user may apply different amounts of pressure by squeezing the computing device, for example, to indicate different levels of significance associated with portions of video clips during video capture or playback. The squeezing or force applied to the computing device may be processed and utilized as explained above with regards to sensors placed under or embedded in a display screen of the computing device.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware, firmware, and/or software components, or integrated within common or separate hardware or software components.

The techniques described in this disclosure may also be embodied or encoded in a computer-readable medium, such as a computer-readable storage medium, containing instructions. Instructions embedded or encoded in a computer-readable medium may cause one or more programmable processors, or other processors, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

In an exemplary implementation, techniques described in this disclosure may be performed by a digital video coding hardware apparatus, whether implemented in part by hardware, firmware and/or software.

Various aspects and examples have been described. However, modifications can be made to the structure or techniques of this disclosure without departing from the scope of the following claims.

1. A method comprising:
detecting pressure applied by a user to a surface of a video capturing device for a plurality of video frames; and
marking at least some of the frames to indicate a significance of the frames based on the detected pressure.

2. The method of claim 1, wherein the pressure is applied during one of capturing or playing back of the video frame.

3. The method of claim 1, wherein marking comprises:
identifying frames for which the detected pressure exceeds a threshold; and
marking the identified frames.

4. The method of claim 1, wherein the surface comprises a display screen of the video capturing device.

5. The method of claim 1, wherein marking comprises modifying header information associated with the marked frames to indicate an amount of the detected pressure for the respective frames.

6. The method of claim 1, wherein marking comprises marking the frames to indicate one of a plurality of different significance levels based on amounts of detected pressure for the respective marked frames.

7. The method of claim 1, wherein marking comprises storing data to indicate the significance of the frames.

8. The method of claim 1, wherein marking comprises:
correlating amounts of the detected pressure with video frames captured at the times the amounts are detected; and
generating data indicating the correlations of the amounts of the detected pressure with the captured video frames.

9. The method of claim 1, further comprising, during playback of the video frames, playing back non-marked frames using a first playback speed and marked frames using at least a second playback speed different from the first playback speed.

10. The method of claim 9, wherein the first playback speed is faster than the at least second playback speed.

11. The method of claim 1, wherein marking comprises, during playback of the video frames, playing back the marked frames at different playback speeds selected based on amounts of the pressure detected for the video frames.

12. The method of claim 1, further comprising displaying at least some of the plurality of video frames as images for editing, and presenting the images for marked video frames differently from the images for non-marked video frames.

13. The method of claim 1, further comprising displaying at least some of the plurality of video frames as images for editing, and sorting the images based on whether the frames corresponding to the images are marked frames or non-marked frames.

14. The method of claim 13, wherein sorting comprises sorting the images in a sorting order that corresponds to amounts of detected pressure for the marked frames.

15. The method of claim 1, further comprising coding the plurality of video frames with a coding quality for marked frames that is different from a coding quality for the non-marked frames.

16. The method of claim 15, wherein coding comprises coding the marked frames with different coding qualities based on amounts of detected pressure for the respective marked frames.

17. The method of claim 1, further comprising displaying on a display screen a visual indication of the detected pressure.

18. The method of claim 1, further comprising determining an average significance of the plurality of video frames based on the significance of the at least some of the frames.

19. A device comprising:
a sensor that detects pressure applied by a user to a surface of a video capturing device for a plurality of video frames; and
at least one processor that marks at least some of the frames to indicate a significance of the frames based on the detected pressure.

20. The device of claim 19, wherein the at least one processor is configured to:
identify frames for which the detected pressure exceeds a threshold; and
mark the identified frames.

21. The device of claim 19, wherein the surface comprises a display screen of the video capturing device.

22. The device of claim 19, wherein the at least one processor is configured to modify header information associated with the marked frames to indicate an amount of the detected pressure for the respective frames.

23. The device of claim 19, wherein the at least one processor is configured to mark the frames to indicate one of a plurality of different significance levels based on amounts of detected pressure for the respective marked frames.

24. The device of claim 19, wherein the at least one processor is configured to store data to indicate the significance of the frames.

25. The device of claim 19, wherein the at least one processor is configured to:
correlate amounts of the detected pressure with video frames captured at the times the amounts are detected; and
generate data indicating the correlations of the amounts of the detected pressure with the captured video frames.

26. The device of claim 19, wherein the at least one processor is configured to, during playback of the video frames, play back non-marked frames using a first playback speed and marked frames using at least a second playback speed different from the first playback speed.

27. The device of claim 26, wherein the first playback speed is faster than the at least second playback speed.

28. The device of claim 19, wherein the at least one processor is configured to, during playback of the video frames, play back the marked frames at different playback speeds selected based on amounts of the pressure detected for the video frames.

29. The device of claim 19, wherein the at least one processor is configured to display at least some of the plurality of video frames as images for editing, and present the images for marked video frames differently from the images for non-marked video frames.

30. The device of claim 19, wherein the at least one processor is configured to display at least some of the plurality of video frames as images for editing, and sort the images based on whether the frames corresponding to the images are marked frames or non-marked frames.

31. The device of claim 30, wherein the at least one processor is configured to sort the images in a sorting order that corresponds to amounts of detected pressure for the marked frames.

32. The device of claim 19, wherein the at least one processor is configured to code the plurality of video frames with a coding quality for marked frames that is different from a coding quality for the non-marked frames.

33. The device of claim 32, wherein the at least one processor is configured to code the marked frames with different coding qualities based on amounts of detected pressure for the respective marked frames.

34. The device of claim 19, further comprising a display screen that displays a visual indication of the detected pressure.

35. The device of claim 19, wherein the at least one processor is configured to determine an average significance of the plurality of video frames based on the significance of the at least some of the frames.

36. A computer-readable medium comprising instructions for causing a programmable processor in a video capturing device to:
detect pressure applied by a user to a surface of a video capturing device for a plurality of video frames; and
mark at least some of the frames to indicate a significance of the frames based on the detected pressure.

37. The computer-readable medium of claim 36, wherein the instructions to mark comprise instructions that cause the processor to:
identify frames for which the detected pressure exceeds a threshold; and
mark the identified frames.

38. The computer-readable medium of claim 36, wherein the surface comprises a display screen of the video capturing device.

39. The computer-readable medium of claim 36, wherein the instructions to mark comprise instructions that cause the processor to modify header information associated with the marked frames to indicate an amount of the detected pressure for the respective frames.

40. The computer-readable medium of claim 36, wherein the instructions to mark comprise instructions that cause the processor to mark the frames to indicate one of a plurality of different significance levels based on amounts of detected pressure for the respective marked frames.

41. The computer-readable medium of claim 36, wherein the instructions to mark comprise instructions that cause the processor to store data to indicate the significance of the frames.

42. The computer-readable medium of claim 36, wherein the instructions to mark comprise instructions that cause the processor to:
correlate amounts of the detected pressure with video frames captured at the times the amounts are detected; and
generate data indicating the correlations of the amounts of the detected pressure with the captured video frames.

43. The computer-readable medium of claim 36, further comprising instructions that cause the processor to, during playback of the video frames, play back non-marked frames using a first playback speed and marked frames using at least a second playback speed different from the first playback speed.

44. The computer-readable medium of claim 43, wherein the first playback speed is faster than the at least second playback speed.

45. The computer-readable medium of claim 36, wherein the instructions to mark comprise instructions that cause the processor to, during playback of the video frames, play back the marked frames at different playback speeds selected based on amounts of the pressure detected for the video frames.

46. The computer-readable medium of claim 36, further comprising instructions that cause the processor to display at least some of the plurality of video frames as images for editing, and present the images for marked video frames differently from the images for non-marked video frames.

47. The computer-readable medium of claim 36, further comprising instructions that cause the processor to display at least some of the plurality of video frames as images for editing, and sort the images based on whether the frames corresponding to the images are marked frames or non-marked frames.

48. The computer-readable medium of claim 47, wherein the instructions to sort comprise instructions that cause the processor to sort the images in a sorting order that corresponds to amounts of detected pressure for the marked frames.

49. The computer-readable medium of claim 36, further comprising instructions that cause the processor to code the plurality of video frames with a coding quality for marked frames that is different from a coding quality for the non-marked frames.

50. The computer-readable medium of claim 49, wherein the instructions to code comprise instructions that cause the processor to code the marked frames with different coding qualities based on amounts of detected pressure for the respective marked frames.

51. The computer-readable medium of claim 36, further comprising instructions that cause the processor to display on a display screen a visual indication of the detected pressure.

52. The computer-readable medium of claim 36, further comprising instructions that cause the processor to determine an average significance of the plurality of video frames based on the significance of the at least some of the frames.

53. A device comprising:
means for detecting pressure applied by a user to a surface of a video capturing device for a plurality of video frames; and
means for marking at least some of the frames to indicate a significance of the frames based on the detected pressure.

54. The device of claim 53, wherein the means for marking comprise:
means for identifying frames for which the detected pressure exceeds a threshold; and
means for marking the identified frames.

55. The device of claim 53, wherein the surface comprises a display screen of the video capturing device.

56. The device of claim 53, wherein the means for marking comprise means for modifying header information associated with the marked frames to indicate an amount of the detected pressure for the respective frames.

57. The device of claim 53, wherein the means for marking comprise means for marking the frames to indicate one of a plurality of different significance levels based on amounts of detected pressure for the respective marked frames.

58. The device of claim 53, wherein the means for marking comprise means for storing data to indicate the significance of the frames.

59. The device of claim 53, wherein the means for marking comprise:
means for correlating amounts of the detected pressure with video frames captured at the times the amounts are detected; and
means for generating data indicating the correlations of the amounts of the detected pressure with the captured video frames.

60. The device of claim 53, further comprising, during playback of the video frames, means for playing back non-marked frames using a first playback speed and marked frames using at least a second playback speed different from the first playback speed.

61. The device of claim 60, wherein the first playback speed is faster than the at least second playback speed.

62. The device of claim 53, wherein the means for marking comprise means for, during playback of the video frames, playing back the marked frames at different playback speeds selected based on amounts of the pressure detected for the video frames.

63. The device of claim 53, further comprising means for displaying at least some of the plurality of video frames as images for editing, and presenting the images for marked video frames differently from the images for non-marked video frames.

64. The device of claim 53, further comprising means for displaying at least some of the plurality of video frames as images for editing, and sorting the images based on whether the frames corresponding to the images are marked frames or non-marked frames.

65. The device of claim 64, wherein the means for sorting comprise means for sorting the images in a sorting order that corresponds to amounts of detected pressure for the marked frames.

66. The device of claim 53, further comprising means for coding the plurality of video frames with a coding quality for marked frames that is different from a coding quality for the non-marked frames.

67. The device of claim 66, wherein the means for coding comprise means for coding the marked frames with different coding qualities based on amounts of detected pressure for the respective marked frames.

68. The device of claim 53, further comprising means for displaying on a display screen a visual indication of the detected pressure.

69. The device of claim 53, further comprising means for determining an average significance of the plurality of video frames based on the significance of the at least some of the frames.
